(19) United States
(12) Patent Application Publication
(10) Pub. No.: US 2008/0246689 A1
(43) Pub. Date: Oct. 9, 2008

(54) MIMO ANTENNA

(75) Inventors: XIANG-HONG QIN, Shenzhen (CN); JIA-LIN TENG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/934,092

(22) Filed: Nov. 2, 2007

(30) Foreign Application Priority Data
Apr. 6, 2007 (CN) 200710200405.X

(51) Int. Cl. H01Q 21/00; H01Q 9/04

(52) U.S. Cl. 343/893; 343/700 MS

(57) ABSTRACT

A MIMO antenna is disposed on a substrate. The substrate includes a first surface and a second surface. The MIMO antenna includes a first antenna and a second antenna set as mirror image to the first antenna, each of the first and the second antennas includes a radiation body, a feeding portion, and a grounded portion. The radiation portion is disposed on the first surface for transceiving electromagnetic signals. The radiation body includes a first radiation portion and a second radiation portion electronically connected to the first radiation portion. The first radiation portion is serpentine-shaped and the second radiation portion is rectangular-shaped. The feeding portion is disposed on the first surface, and electronically connected to the second radiation portion for feeding electromagnetic signals to the radiation body. The grounded portion is disposed on the second surface.

### BACKGROUND OF THE INVENTION

1. Field of the Invention

The present invention relates to wireless communication, and particularly to a Multi Input Multi Output antenna.

2. Description of Related Art

Recently, the Multi Input Multi Output (MIMO) technology has achieved significant growth due to the ever growing demand for wireless communication products. MIMO antennas are widely used in the field of wireless communication. Generally, a MIMO antenna includes at least two individual antennas. Each antenna should be designed as small as possible and the isolation between the antennas should be designed to satisfy space and radiation requirements of wireless local area network (WLAN) devices employing the antennas.

### SUMMARY OF THE INVENTION

One aspect of the present invention provides a Multi Input Multi Output (MIMO) antenna. The MIMO antenna is disposed on a substrate. The substrate includes a first surface and a second surface. The MIMO antenna includes a first antenna and a second antenna set as mirror image to the first antenna, each of the first and the second antennas includes a radiation body, a feeding portion, and a grounded portion. The radiation portion is disposed on the first surface for transceiving electromagnetic signals. The radiation body includes a first radiation portion and a second radiation portion electronically connected to the first radiation portion. The first radiation portion is serpentine-shaped and the second radiation portion is rectangular-shaped. The feeding portion is disposed on the first surface, and electronically connected to the second radiation portion for feeding electromagnetic signals to the radiation body. The grounded portion is disposed on the second surface.

Other objectives, advantages and novel features of the present invention will be drawn from the following detailed description of preferred embodiments of the present invention with the attached drawings, in which:

### BRIEF DESCRIPTION OF THE DRAWINGS

FIG. 1 is a front view schematic diagram of a Multi Input Multi Output (MIMO) antenna in accordance with an embodiment of the invention;

FIG. 2 is a back view schematic diagram of the MIMO antenna of FIG. 1;

FIG. 3 and FIG. 4 are schematic diagrams illustrating dimensions of the MIMO antenna of FIG. 1 and FIG. 2;

FIG. 5 is a graph of test results showing voltage standing wave ratios (VSWRs) of a first antenna of the MIMO antenna of FIG. 1;

FIG. 6 is a graph of test results showing the VSWRs of a second antenna of the MIMO antenna of FIG. 1; and

FIG. 7 is a graph of test results showing isolation between the first antenna and the second antenna of the MIMO antenna of FIG. 1.

### DETAILED DESCRIPTION OF THE INVENTION

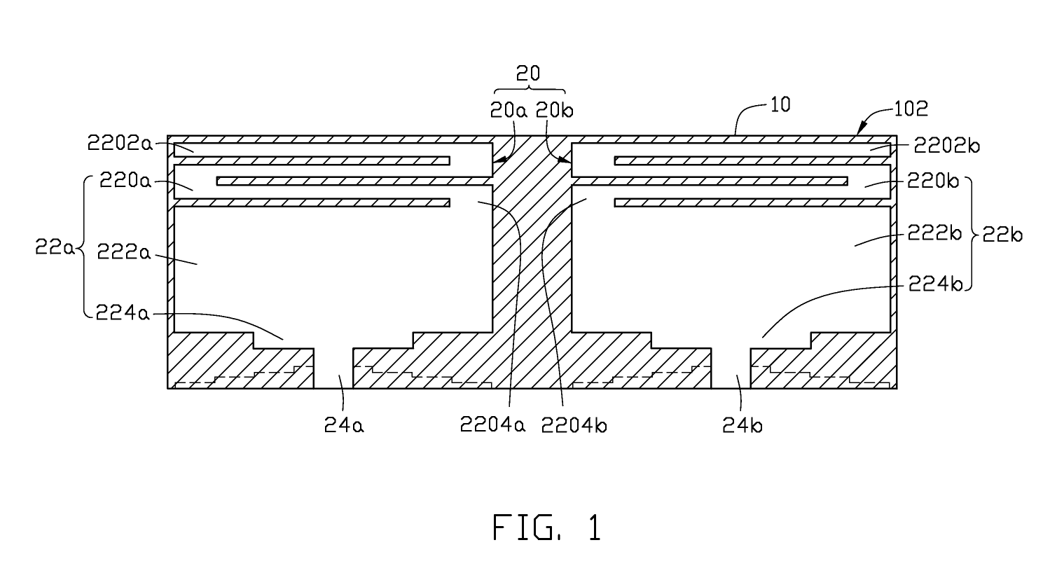

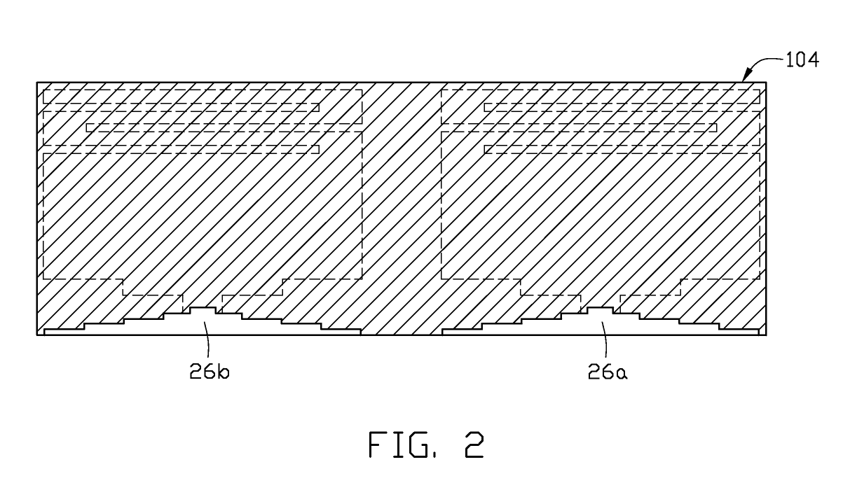

FIG. 1 and FIG. 2 are respectively front and back views of a Multi Input Multi Output (MIMO) antenna 20 in accordance with an embodiment of the invention.

In this embodiment, the MIMO antenna 20 is disposed on a substrate 10. The substrate 10 includes a first surface 102 (as shown in FIG. 1) and a second surface 104 (as shown in FIG. 2) opposite to the first surface 102. The MIMO antenna 20 includes at least a first antenna 20a and a second antenna 20b. The first antenna 20a is set as mirror image to the second antenna 20b, that is, the first antenna 20a and the second antenna 20b are in axial symmetry.

The first antenna 20a includes a radiation body 22a, a feeding portion 24a, and a grounded portion 26a. The radiation body 22a includes a first radiation portion 220a, a second radiation portion 222a, and a connecting portion 224a.

The second antenna 20b similarly includes a radiation body 22b, a feeding portion 24b, and a grounded portion 26b. The radiation body 22b includes a first radiation portion 220b, a second radiation portion 222b, and a connecting portion 224b.

The radiation bodies 22a, 22b are disposed on the first surface 102, for transceiving electromagnetic signals. The first radiation portions 220a, 220b are serpentine-shaped, and each includes an open end 2202a (2202b) and a connecting end 2204a (2204b) electronically connected to the second radiation portion 222a (222b). In this embodiment, the connecting end 2204a is disposed adjacent to the connecting end 2204b. The open ends 2202a and 2202b are mirror images of each other and extend in opposite directions. In this way, the isolation between the first antenna 20a and the second antenna 20b is improved. The connecting portion 224a (224b) is electronically connected between the second radiation portion 222a (222b) and the feeding portion 24a (24b). The feeding portion 24a (24b) is disposed on the first surface 102, and electronically connected to the second radiation portion 222a (222b). The feeding portion 24a (24b) is used for feeding electromagnetic signals to the radiation body 22a (22b). The grounded portions 26a, 26b are disposed on the second surface 104.

In this embodiment, the first radiation portion 220a (220b) can reduce the rectilinear length of the radiation body 22a (22b) yet still keep the radiation body 22a (22b) resonating. A radiation field produced by a coupling effect of the first radiation portions 220a, 220b can improve the radiation efficiency of the MIMO antenna 20. In other words, the first radiation portions 220a and 220b can reduce the area of the MIMO antenna 20, and improve the radiation efficiency of the MIMO antenna 20. In this embodiment, the first radiation portion 220a (220b) has a selected one of an s-shaped configuration, a w-shaped configuration, and a u-shaped configuration.

The second radiation portions 222a, 222b and the connecting portions 224a, 224b are rectangle-shaped. In this embodiment, a length and a width of the connecting portion 224a (224b) are smaller than those of the second radiation portion 222a (222b). The connecting portion 224a (224b) has matching impedance function.

The grounded portions 26a, 26b are step-shaped and in axial symmetry along an axis of the first surface 102. In this embodiment, the grounded portions 26a, 26b can improve the radiation efficiency of the MIMO antenna 20.

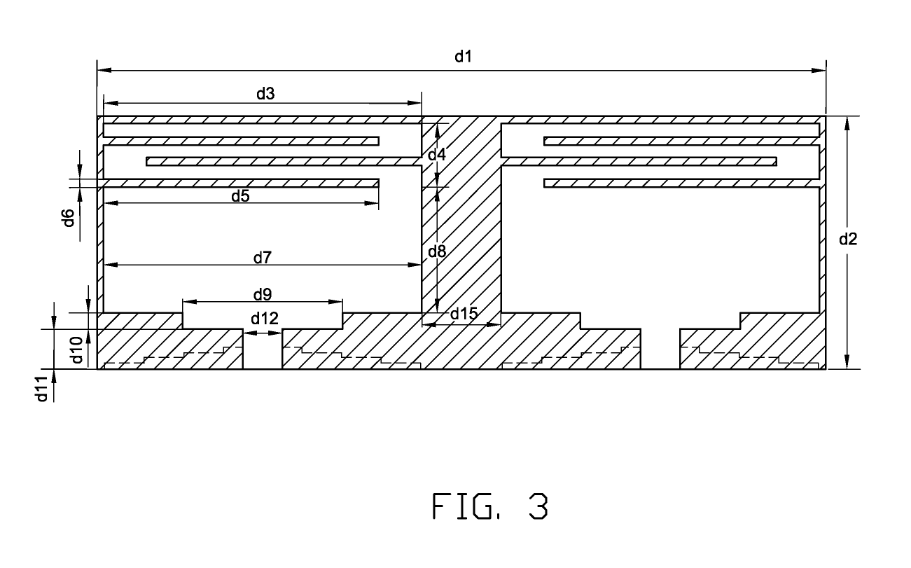

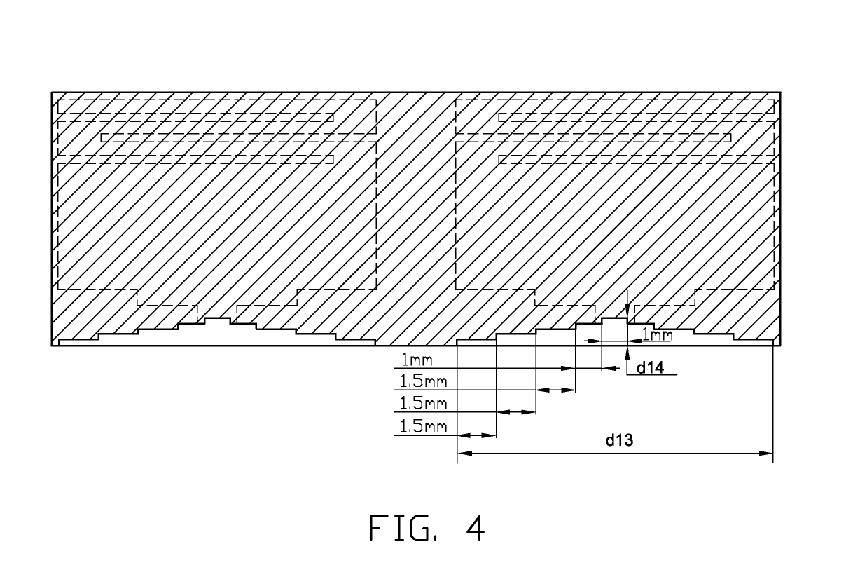

FIG. 3 and FIG. 4 jointly illustrate dimensions of the MIMO antenna 20 of FIG. 1 and FIG. 2.

In this embodiment, a total length d1 of the MIMO antenna 20 is 27.5 millimeter (mm), and a total width d2 of the MIMO antenna 20 is 9.5 mm. All dimensions of all parts of the first antenna 20a are the same as those of the second antenna 20b. In order to describe succinctly, we just illustrate dimensions of the first antenna 20a. The first radiation 220a is serpentine-shaped. A total length d3 of the first radiation 220a is 12 mm, and a total width d4 of the first radiation 220a is 2.4 mm. A length d5 of the slot of the first radiation 220a is 10.4 mm, and a width d6 of the slot of the first radiation 220a is 0.3 mm. The second radiation portion 222a, the connecting portion 224a, and the feeding portion 24a are rectangle-shaped. A length d7 of the second radiation portion 222a is 12 mm, and a width d8 of the second radiation portion 222a is 4.725 mm. A length d9 of the connecting portion 224a is 6 mm, and a width d10 of the connecting portion 224a is 0.5 mm. A length d11 of the feeding portion 24a is 1.675 mm, and a width d12 of the feeding portion 224a is 1.5 mm. The parallel distance d15 between the first antenna 20a and the second antenna 20b is 3 mm.

In FIG. 4, a total width d13 of the grounded portion 26a is 12 mm, and a total height d14 of the grounded portion 26a is 1 mm. The grounded portion 26a is step-shaped and symmetrical along an axis, and the projection of the axis on the first surface 102 and the feeding portion 24a partially overlap. The grounded portion 26a has 5 steps, and a height of each step is about 0.2 mm. Widths of the fourth step and the fifth step are about 1 mm, and widths of the other steps are about 1.5 mm. In other embodiments, the grounded portion 26a may be other shaped so long as the overall dimensions remain at about 1 mm high by about 12 mm wide.

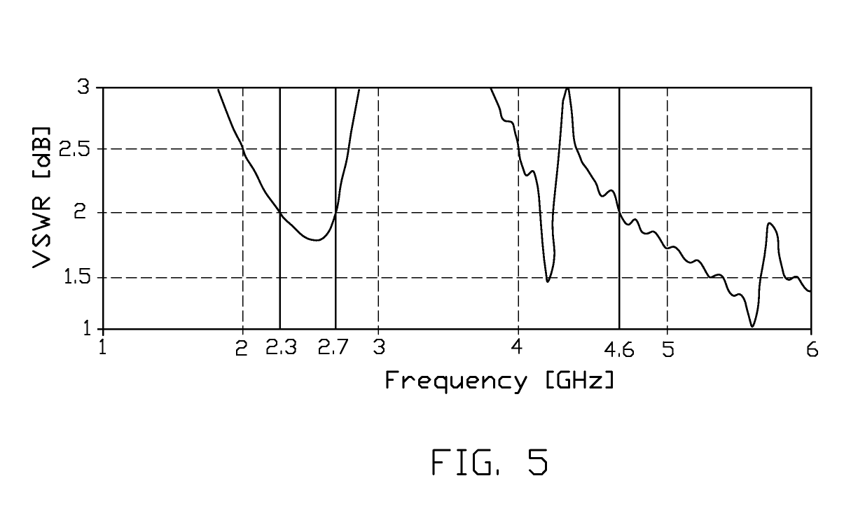

FIG. 5 is a graph of test results showing voltage standing wave ratios (VSWRs) of the first antenna 20a of the MIMO antenna 20 of FIG. 1. The horizontal axis represents the frequency (in GHz) of the electromagnetic signals traveling through the first antenna 20a, and the vertical axis represents amplitude of the VSWRs. A curve shows the amplitude of the VSWRs of the first antenna 20a at operating frequencies. As shown in FIG. 5, the first antenna 20a performs well when operating at frequency bands of 2.3-2.7 GHz and 4.6-6.0 GHz. The amplitude values of the VSWRs in the band pass frequency range are smaller than a value of 2, indicating the first antenna 20a complies with application requirements of the MIMO antenna 20.

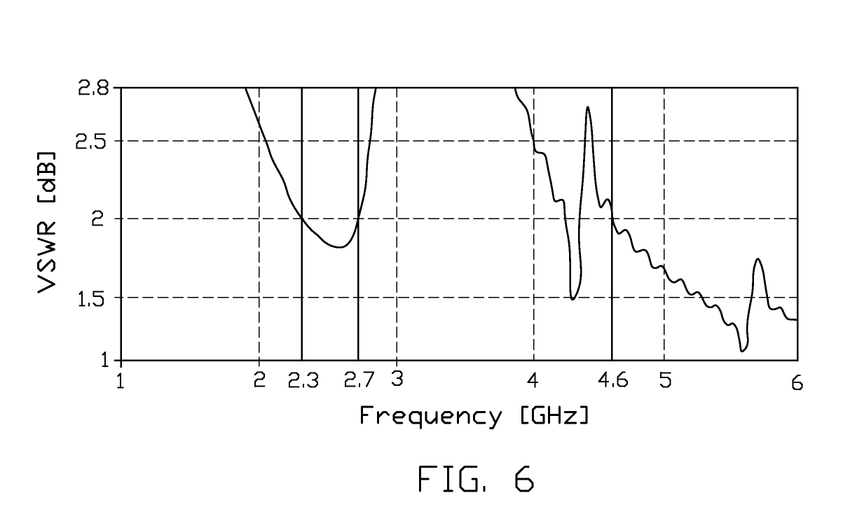

FIG. 6 is a graph of test results showing VSWRs of the second antenna 20b of the MIMO antenna 20 of FIG. 1. The horizontal axis represents the frequency (in GHz) of the electromagnetic signals traveling through the second antenna 20b, and the vertical axis represents amplitude of the VSWRs. A curve shows the amplitude of the VSWRs of the second antenna 20b at operating frequencies. As shown in FIG. 6, the second antenna 20b performs well when operating at frequency bands of 2.3-2.7 GHz and 4.6-6.0 GHz. The amplitude values of the VSWRs in the band pass frequency range are smaller than a value of 2, indicating the second antenna 20b complies with application requirement of the MIMO antenna 20.

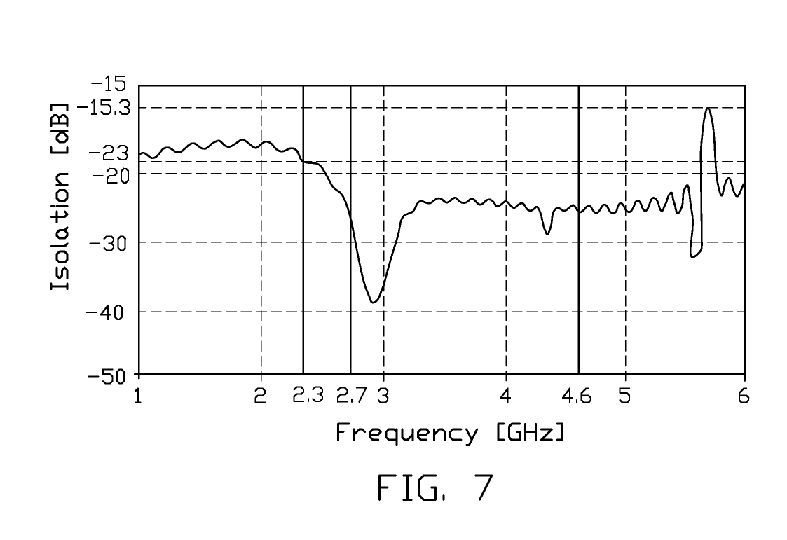

FIG. 7 is a graph of test results showing isolation between the first antenna 20a and the second antenna 20b of the MIMO antenna 20 of FIG. 1. The horizontal axis represents the frequency (in GHz) of the electromagnetic signals traveling through the MIMO antenna 20, and the vertical axis represents the amplitude of the isolation. As shown in FIG. 7, a curve shows isolation between the first antenna 20a and the second antenna 20b is at most substantially −23 dB when the MIMO antenna 20 operates at frequency band of 2.3-2.7 GHz. Isolation between the first antenna 20a and the second antenna 20b is at most substantially −15.3 dB when the MIMO antenna 20 operates at frequency band of 4.6-6.0 GHz. The isolation values of the two bands are smaller than −10, indicating the MIMO antenna 20 complies with application requirement of a MIMO antenna.

In this embodiment, the first radiation portion 220a (220b) is serpentine-shaped. Therefore, the area of the MIMO antenna 20 is reduced. The grounded portion 26a (26b) improves the VSWRs of the MIMO antenna 20 operating at the pass bands.

What is claimed is:

1. A Multi Input Multi Output (MIMO) antenna, disposed on a substrate comprising a first surface and a second surface, the MIMO antenna comprising a first antenna and a second antenna set as mirror image to the first antenna, each of the first and the second antennas comprising:
a radiation body, disposed on the first surface, for transceiving electromagnetic signals, the radiation body comprising a first radiation portion and a second radiation portion electronically connected to the first radiation portion, the first radiation portion being serpentine-shaped, the second radiation portion being rectangular-shaped;
a feeding portion, disposed on the first surface, and electronically connected to the second radiation portion, for feeding electromagnetic signals to the radiation body; and
a grounded portion, disposed on the second surface.

2. The MIMO antenna as recited in claim 1, further comprising a connecting portion electronically connected between the second radiation portion and the feeding portion.

3. The MIMO antenna as recited in claim 2, wherein the connecting portion is rectangle-shaped.

4. The MIMO antenna as recited in claim 3, wherein a width and a length of the connecting portion are smaller than those of the second radiation portion.

5. The MIMO antenna as recited in claim 1, wherein the first radiation portion has a selective one of an s-shaped configuration, a w-shaped configuration, and a u-shaped configuration.

6. The MIMO antenna as recited in claim 5, wherein the first radiation portion comprises an open end and a connecting end electronically connected to the second radiation portion.

7. The MIMO antenna as recited in claim 6, wherein the connecting end of the first antenna is disposed adjacent to the connecting end of the second antenna.

8. The MIMO antenna as recited in claim 7, wherein the open end of the first antenna and the open end of the second antenna are mirror images of each other and extends in opposite directions.

9. The MIMO antenna as recited in claim 1, wherein the grounded portion is step-shaped and symmetrical along an axis of the first surface.

10. A Multi Input Multi Output (MIMO) antenna disposed on a substrate comprising at least two surfaces, the MIMO antenna comprising at least two individual antennas, each of the individual antennas comprising:
a radiation body, disposed on one of the surfaces for radiating electromagnetic signals, the radiation body comprising a first radiation portion and a second radiation portion electronically connected to the first radiation portion, the first radiation portion being serpentine-shaped, the second radiation portion being rectangular-shaped;
a feeding portion, disposed on the same surface as the radiation body, and electronically connected to the second radiation portion, for feeding electromagnetic signals to the radiation body; and
a grounded portion, disposed on the other surface of the substrate;
wherein the at least two individual antennas are in axial symmetry.

11. The MIMO antenna as recited in claim 10, wherein the grounded portion is step-shaped.

12. The MIMO antenna as recited in claim 10, wherein the first radiation portion comprises an open end, and a connecting end electronically connected to the second radiation portion.

13. The MIMO antenna as recited in claim 12, wherein the open ends of the at least two antennas extend in opposite direction.

14. The MIMO antenna as recited in claim 10, wherein the first radiation portion is in an s-shape, a w-shape, or a u-shape.

15. A Multi Input Multi Output (MIMO) antenna assembly, comprising
a substrate comprising two opposite surfaces; and
at least two individual antennas formed side by side along said two opposite surfaces of said substrate, each of said at least two individual antennas comprising a radiation body formed on one of said two opposite surfaces for radiating electromagnetic signals, and a grounded portion formed on the other of said two opposite surfaces, said radiation body comprising a serpentine-shaped radiation portion formed at one end thereof, and a feeding portion for feeding electromagnetic signals to said radiation body electrically connectable with the other end of said radiation body opposite to said one end of said radiation body having said serpentine-shaped radiation portion, said serpentine-shaped radiation portion of one of said at least two individual antennas being symmetrically formed to said serpentine-shaped radiation portion of another of said at least two individual antennas neighboring said one of said at least two individual antennas along said one of said two opposite surfaces.

16. The MIMO antenna assembly as recited in claim 15, wherein a rectangular-shaped radiation portion is formed in said radiation body and is electrically connectable between said serpentine-shaped radiation portion of said radiation body and said feeding portion.

17. The MIMO antenna assembly as recited in claim 15, wherein said grounded portions of said at least two individual antennas are step-shaped respectively, and said grounded portion of said one of said at least two individual antennas is symmetrically formed to said grounded portion of said another of said at least two individual antennas.
